(19) United States
(12) Patent Application Publication
(10) Pub. No.: US 2007/0131912 A1
(43) Pub. Date: Jun. 14, 2007

(54) Electrically conductive adhesives

(76) Inventors: Davide Louis Simone, Clifton Park, NY (US); Thomas Martin Angeliu, Clifton Park, NY (US); Sandeep Shrikant Tonapi, Niskayuna, NY (US); David Alexander Gibson, Scotia, NY (US); Jian Zhang, Schenectady, NY (US)

Correspondence Address: GENERAL ELECTRIC COMPANY;GLOBAL RESEARCH, PATENT DOCKET RM. BLDG. K1-4A59, NISKAYUNA, NY, 12309, US

(21) Appl. No.: 11/177,901

(22) Filed: Jul. 8, 2005

(51) Int. Cl. H01B 1/12

(52) U.S. Cl. 252/500

(57) ABSTRACT

The present invention provides an electrically conductive adhesive composition having cured low modulus elastomer and metallurgically-bonded micron-sized metal particles and nano-sized metal particles. The low modulus elastomer provides the mechanical robustness and reliability by relieving the stresses generated; and the metallurgically-bonded micron-sized metal particles and nano-sized metal particles provide a continuous conducting path with minimized interface resistance. Addition of nano-sized metal particles lowers the fusion temperature and allows the metallurgical-bonding to occur at manageable temperatures.

### BACKGROUND

The invention relates generally to electrically conductive adhesives and more specifically to such adhesives having a cured low modulus elastomer and metallurgically-bonded nano-sized metal particles and micron-sized metal particles.

Reliable performance of electronic devices depends on the integrity and adhesion of the microelectronic components contained therein. Incorporating multiple components into a device creates several adhesive interfaces, interconnections, bonds, and so on, robustness of which is typically important for survival of the device during assembly and for reliability of the device during its subsequent service life. Adhesive interfaces, bonds, and connections, and the like, within electronic components are currently subjected to increasingly stringent selection requirements.

For example, environmental concerns have resulted in a worldwide mandate to remove lead from all aspects of the microelectronic assembly process. The use of lead-free solder alloys, however, creates a new challenge for the reliable assembly of microelectronics components. The reflow temperatures required by lead-free alloys such as tin-copper-silver alloys are several degrees higher than those containing lead. Soldering operations based on these alloys generally must be conducted around 260° C., which is about forty degrees Celsius higher than the eutectic tin-lead alloy solder, for example. Unfortunately, the higher processing temperatures of lead-free alloy solders commonly exceed the design temperature of many circuit board materials. Thus, incorporation of lead-free solders may not be feasible in certain applications and/or may lead to higher material costs where more expensive circuit board materials having higher design temperatures are utilized. Further, such an increase in processing temperatures can lead to increases in thermal stresses on the components being connected and hence reduced robustness. Moreover, increased processing temperatures generally increase energy consumption/costs in the fabrication of circuit boards and other devices.

In response, electrically conductive adhesives (ECAs) provide a promising alternative to eutectic tin-lead solder and other lead-free alloy solders as an interconnect material and other uses. In general, ECAs provide a mechanical bond between two surfaces and conduct electricity. Typically, ECA formulations are made of a polymer resin filled with conductive metal particles. The resin generally provides a mechanical bond between two substrates, while the conductive filler particles generally provide the desired electrical interconnection. Typically, ECAs offer the following advantages: lower processing temperatures, reduced environmental impact, and increased resistance to thermomechanical fatigue.

In addition, at least three trends may drive the demand for electrically conductive adhesives. First, device miniaturization in certain applications is increasing demand for fine pitch capabilities which may be facilitated by employing finer (smaller) filler particles in ECAs. Second, the amount of heat generated by increasingly powerful integrated circuits may be managed with the material-selection in ECAs to advance the overall device performance. Third, ECAs may adhere non-solderable or thermally sensitive substrates, such as glass and plastics, which are becoming increasingly popular in electronic design. It should be emphasized that many other demands and opportunities may be addressed with the use of ECAs.

While conductive adhesives having conductive fillers may have potential advantages in electrical conduction applications, they may also pose challenges, such as the relatively low electrical conductivity of the polymeric portion of the adhesive. Moreover, a particular challenge with filled composites (e.g., metal-filled) is implementing the appropriate balance of filler loading, adhesive strength, and electrical conductivity. For example, as filler loading is increased in an effort to advance electrical conductivity, the composite's adhesion may suffer, thereby reducing or limiting the conductivity. Furthermore, conduction between filler particles in a composite is generally limited to filler-filler point contacts.

Indeed, properties of the interface between metallic fillers may contribute to degradation of the electrical properties of the polymer composites. In addition, as indicated, because the filler size of the polymer composite affects the minimum pitch size of the electronic circuits in which the composite can be employed, it is generally desired to utilize finer particles in the polymer composite to lower the minimum pitch size. The fine particles, however, create more interfaces between the particles because of their larger surface area, further contributing to the degradation of electrical conductivity and thus making use of fine particles less beneficial.

Hence there is a need for new electrically conductive adhesive compositions and methods of generating the same in order to achieve the desired adhesion and electrical conductivity between microelectronic components.

### BRIEF DESCRIPTION

Briefly in accordance with an exemplary embodiment of the present invention, an adhesive composition is presented. The composition includes a cured low modulus elastomer and metallurgically-bonded nano-sized metal particles (nano particles) and micron-sized metal particles (micron particles). Furthermore, the adhesive composition is electrically conductive.

According to a further embodiment of the present invention, an adhesive composition having a cured polysiloxane and metallurgically-bonded nano-sized silver particles and micron-sized silver particles is presented. Furthermore, the adhesive composition is electrically conductive

In accordance with an exemplary embodiment of the present invention, a method of making an adhesive composition is presented. The method includes contacting a curable low modulus elastomer with nano-sized metal particles and micron-sized metal particles. Furthermore, the method includes heating to form the adhesive composition having cured low modulus elastomer and metallurgically-bonded nano-sized metal particles and micron-sized metal particles, such that the adhesive composition is electrically conductive.

According to a further embodiment of the present invention, a method of making an adhesive composition having cured polysiloxane and metallurgically-bonded nano-sized silver particles and micron-sized silver particles is presented. The method includes contacting a curable polysiloxane with nano-sized silver particles and micron-sized silver particles. Furthermore, the method includes heating to form the adhesive composition, such that the adhesive composition is electrically conductive.

### DRAWINGS

These and other features, aspects, and advantages of the present invention will become better understood when the following detailed description is read with reference to the accompanying drawings in which like characters represent like parts throughout the drawings, wherein:

FIG. 1 is a cross-section of a diagrammatical representation of an electronic device having an electrically conductive adhesive containing an elastomer, micron particles and nano particles in accordance with embodiments of the present technique;

FIG. 2 is a cross-section of a diagrammatical representation of the electronic device of FIG. 1 having the electrically conductive adhesive after curing of the elastomer in accordance with embodiments of the present technique; and

FIG. 3 is an enlarged view of a portion of a cross-section of the adhesive of FIG. 2 depicting metallurgical-bonding between micron particles and nano particles in accordance with embodiments of the present technique.

### DETAILED DESCRIPTION

In the following specification and the claims which follow, reference will be made to a number of terms which shall be defined to have the following meanings.

The singular forms “a”, “an” and “the” include plural referents unless the context clearly dictates otherwise.

As used herein the terms “metallurgically-bonded”, “sintered,” and “fused” will be used interchangeably. The terms “micron-sized metal particles” and “micron particles” will be used interchangeably. The terms “nano-sized metal particles” and “nano particles” will be used interchangeably. The term “metallurgical-bonding” refers to surface diffusion, and/or lattice diffusion, and/or vapor diffusion of metal from one metal particle to another metal particle which may result in neck formation between two or more metal particles. Neck formation resulting in metallurgical-bonding may provide a continuous electrical connection between two or metal particles. The diffusion of metal by the aforementioned mechanisms may occur from the surface, and/or grain boundary, and/or bulk of one metal particle to the surface, and/or grain boundary, and/or bulk of another metal particle. It should be noted that various mechanisms for metallurgical-bonding of the metal particles may be realized. In one example, metallurgical-bonding may occur due to surface diffusion of metal from the surface of one metal particle to the surface/bulk of another metal particle. In another example, metallurgical-bonding may occur due to surface diffusion of metal from the surface of a metal particle into its bulk, followed by bulk diffusion to the surface and neck formation with another particle.

As noted, electrically conductive adhesives, composed of a polymer resin and conducting metal particles have low conductivity due to the presence of interfaces between the metal particles. Although there is generally direct contact between the metal particles, a contact resistance at the interface is generated leading to low electrical performance. This contact resistance may be reduced, for example, by fusion or metallurgical-bonding of metal particles. To fuse these metal particles, the temperature should typically be raised to their melting point. However, in the case of a metal having a relatively high melting point, such as silver (mp. 962° C.), this fusion or metallurgical bonding of particles may not be feasible as the organic substrate on which the adhesive composition is applied, may not be able to withstand such high temperatures.

It has been observed that decreasing the size of the metal particles can reduce the melting point of metal particles. Embodiments of the present technique consist of utilizing the enhanced sintering kinetics of nano particles and nanocrystalline bodies, particularly metal particles, to metallurgically-bond metal particles together in an adhesive matrix. In certain embodiments, nano and micron particles, in a known ratio, are mixed into an elastomer matrix or synthesized directly into the elastomer matrix and cured into a thermosetting adhesive. During the elevated temperature curing process, the nano particles or nanostructured micron-bodies may sinter to each other, to other micron particles and to the substrates in question. The net effect is a substantially continuous metallurgical bond from substrate to substrate through a filled elastomer adhesive containing conductive nano/micron particles.

It should be noted that various metallurgically-bonding configurations of the micron and nano particles may be realized or implemented. For example, in certain embodiments, several nano particles may be metallurgically-bonded to the same micron particle. Further, a nano particle may metallurgically couple two micron particles. In addition, a micron particle may metallurgically bond to another micron particle, and so on. In certain configurations, the metallurgical bonding of micron particle to micron particle may be due, at least in part, to the presence of the nanoparticles.

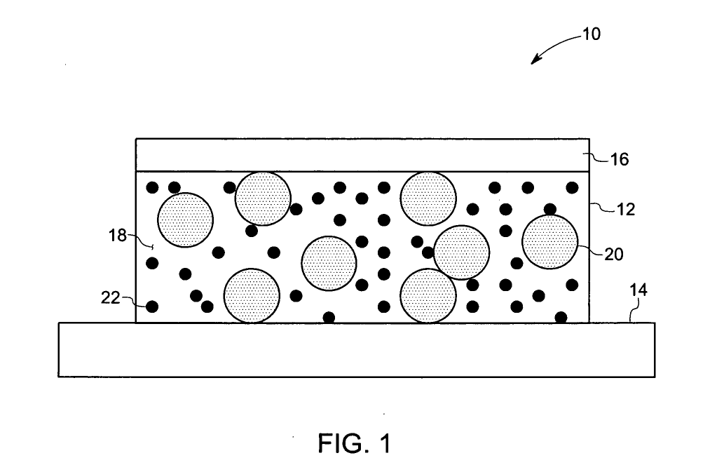

The present technique will now be described in greater details with respect to the accompanying figures. Referring to FIG. 1, a cross-section of an electrical device 10 having an adhesive 12 used to bond and/or connect a substrate 14 and an electronic component 16. It should be emphasized that the terms “adhesive” or “adhesive composition” as used herein may be used in a broad sense to encompass materials employed at the interface between components (e.g., between an electronic component and a heat transfer component, or between a component 16 and a substrate 14, and so forth), materials that connects a component 16 with a substrate 14 and/or with other components, materials used in the packaging of components and devices, materials that facilitate shielding of components or devices (e.g., from electromagnetic/radio interference), and so on. These materials may or may not have significant capability to adhere the components or substrates. In the illustrated embodiment, the adhesive 12 is disposed between the electronic component 16 and the substrate 14. It should be noted that parts (e.g., housing and other components) of the electronic device 10 are not depicted so to emphasize and not obscure illustration of the adhesive 12. Further, the parts of the device 10 depicted are a representation not necessarily drawn to scale.

The composition of the adhesive 12 may include a low modulus elastomer 18, micron particles 20, nano particles 22, and so forth. In the illustrated embodiment, the initial application of the adhesive 12 is depicted prior to curing of the elastomer and prior to the metallurgical bonding of the particles 20 and 22. In this embodiment, the adhesive 12 is utilized to facilitate electrical conductivity between the substrate 14 and component 16. However, it should be emphasized that other adhesives in accordance with embodiments of the present technique may be employed to facilitate electrical conductivity. On the whole, the composition and type of adhesive employed may depend upon the application desired. Further, it should be emphasized that while the present discussion may focus on the present adhesives as electrically conductive, certain embodiments of the present adhesives may also be thermally conductive and employed in thermal applications, such as a thermal interface material (TIM), for example.

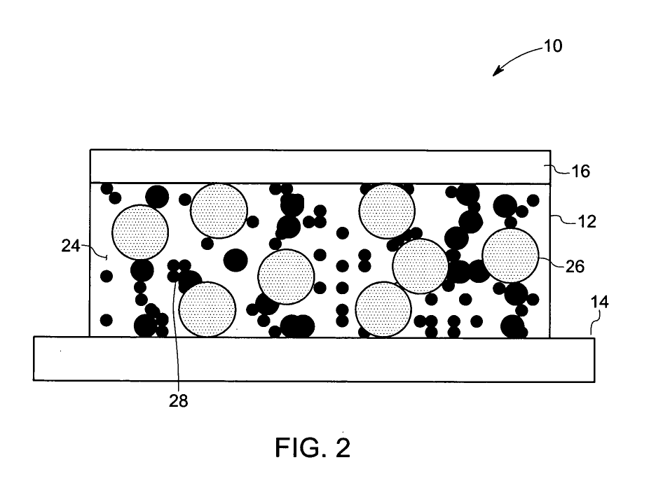

Referring now to FIG. 2, a cross-section of an adhesive composition 12 containing a cured low modulus elastomer 24 and metallurgically-bonded micron particles 26 and nano-particles 28 is illustrated. It should be noted that the cured elastomer 24 corresponds to the uncured elastomer 18 of FIG. 1. Similarly, the metallurgically-bonded particles 26 and 28 correspond to the non-bonded particles 20 and 22 of FIG. 1. The adhesive 12 as noted above, is disposed between an electronic component 16 and a substrate 14 that may be selected depending upon the application desired. In the illustrated embodiment of FIG. 2, the metallurgical-bonding (e.g., sintering and/or fusing) is depicted between two or more nano particles 28, between a nano particle 28 and a micron particle 26, between several nano particles 28 and a micron particle 26, and between two micron particles 26 via a nano particle 28. FIG. 2 also depicts metallurgical-bonding that may occur between the electronic component 16 and/or the substrate 14 to the metallurgically-bonded micron and nano particles. As noted above, the various bonding discussed are some of the many ways in which metallurgical-bonding may occur resulting in a substantially continuous conducting path between the electronic component 16 and the substrate 14.

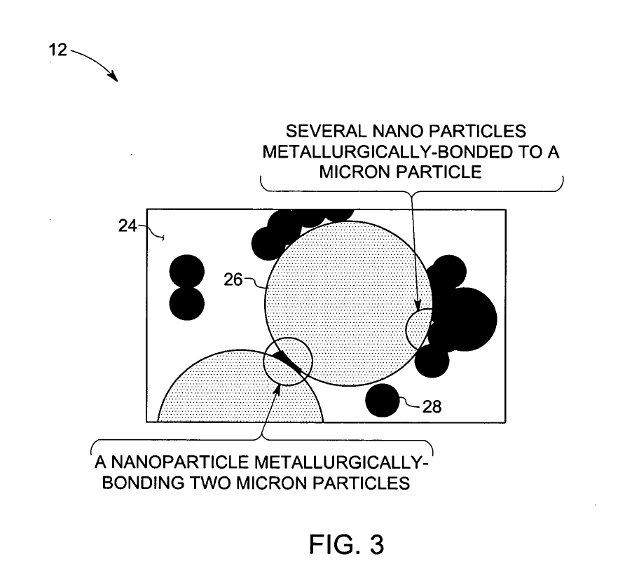

FIG. 3 is an enlarged view of the adhesive 12 described in FIG. 2, illustrating the metallurgical-bonding between the micron and the nano particles 26 and 28. Depicted are some of the examples of metallurgical-bonding mentioned above. For example, a nano particle 28 is metallurgically-bonded to two micron particles 26 resulting in a continuous electrical path between the two micron particles 28 via the nano particle 26. In another example, several nano particles 28 are metallurgically-bonded to each other and also to a micron particle 26, again resulting in a continuous electrical path between the different particles of the composition. It should be emphasized that the mechanism(s) of the metallurgical bonding and the microscopic appearance of the bonded particles may vary widely, depending on the particular application and composition of the adhesive, for example.

In sum, the present technique relates to a conductive adhesive composition having a cured low modulus elastomer and metallurgically-bonded micron-sized metal particles and nano-sized metal particles. The low modulus elastomer generally provides the mechanical robustness and reliability by relieving the stresses generated, for example. In one embodiment of the present invention, the low modulus elastomer includes, but is not limited to, curable polysiloxanes, polyurethanes, neoprene, fluorosilicones, organosilicones, or synthetic rubber.

In a further embodiment of the present invention, the cured elastomer includes a polysiloxane having an average of at least two silicon-bonded alkenyl groups per molecule, a hydridopolysiloxane comprising at least two silicon-bonded hydrogen atoms, a hydrosilylation catalyst, and a hydrosilylation catalyst inhibitor. The alkenyl bearing polysiloxane has the formula:
MₐD_{b}D′_{c}T_{dQ}ₑ
where
M=R¹R²R³SiO_{1/2};
D=R⁴R⁵SiO_{2/2};
D′=R⁶R⁷SiO_{2/2};
T=R⁸SiO_{3/2}; and
Q=SiO_{4/2} with
wherein R¹, R², R⁴, R⁵, R⁶ and R⁸ are independently in each instance a C₁-C₄₀ monovalent hydrocarbon radical, and R³ and R⁷ are independently at each instance a C₂-C₄₀ monovalent alkenyl hydrocarbon radical. The stoichiometric coefficients a and b are non-zero and positive while the stoichiometric coefficients c, d and e are zero or positive subject to the requirement that a+c is greater than or equal to 2. The stoichiometric coefficients b and c are chosen such that the viscosity of the alkenyl bearing polysiloxane ranges from about 50 to about 200,000 centistokes at 25° C. in one embodimemt, from about 100 to about 100,000 centistokes at 25° C. in another embodiment, from about 200 to about 50,000 centistokes at 25° C. in yet another embodiment, and from about 275 to about 30,000 centistokes at 25° C. in a further embodiment.
The hydridopolysiloxane has the formula:
M′_{f}D″_{g}D″′ₕT′ⱼQ′ᵢ
where
M′=R⁹R¹⁰R¹¹SiO_{1/2};
D″=R¹²R¹³SiO_{2/2};
D′″=R¹⁴R¹⁵SiO_{2/2};
T′=R¹⁶SiO_{3/2}; and
Q′=SiO_{4/2} with
wherein R⁹, R¹⁰, R¹², R¹⁴, R⁶ and R¹⁶ are independently at each instance a C₁-C₄₀ monovalent hydrocarbon radical, and R¹¹ and R¹⁵ represents a hydrogen. The stoichiometric coefficients f and g are non-zero and positive while the stoichiometric coefficients h, i and j are zero or positive subject to the requirement that f+g is greater than or equal to 2. The stoichiometric coefficients g and h are chosen such that the viscosity of the hydrogen bearing hydridopolysiloxane ranges from about 1 to about 200,000 centistokes at 25° C. in one embodiment, from about 5 to about 10,000 centistokes at 25° C. in another embodiment, from about 10 to about 5000 centistokes at 25° C. in yet another embodiment, and from about 25 to about 500 centistokes at 25° C. in a further embodiment.

The amount of hydrogen present as hydridosiloxane in the total formulation ranges from about 10 to about 1000 ppm by weight of the total formulation in one embodiment, from about 25 to about 500 ppm by weight of the total formulation in another embodiment, from about 50 to about 250 ppm by weight of the total formulation in yet another embodiment, and from about 80 to about 150 ppm by weight of the total formulation in a further embodiment.

Hydrosilylation catalysts that may be employed in the present invention include, but are not limited to catalysts comprising rhodium, platinum, palladium, nickel, rhenium, ruthenium, osmium, copper, cobalt, iron and combinations thereof. Many types of platinum catalysts for this SiH olefin addition reaction (hydrosilation or hydrosilylation) are known and such platinum catalysts may be used for the reaction in the present instance. The platinum compound can be selected from those having the formula (PtCl₂Olefin) and H(PtCl₃Olefin) as described in U.S. Pat. No. 3,159,601. A further platinum containing material usable in the compositions of the present invention is the cyclopropane complex of platinum chloride described in U.S. Pat. No. 3,159,662. Further, the platinum containing material can be a complex formed from chloroplatinic acid with up to 2 moles per gram of platinum of a member selected from the class consisting of alcohols, ethers, aldehydes and mixtures of the above as described in U.S. Pat. No. 3,220,972. The catalysts used in some embodiments of the present inventions are described in U.S. Pat. No. 3,715,334, U.S. Pat. No. 3,775,452, and U.S. Pat. No. 3,814,730. Additional background concerning the art may be found at J. L. Spier, “Homogeneous Catalysis of Hydrosilation by Transition Metals”, in Advances in Organometallic Chemistry, volume 17, pages 407 through 447, F. G. A. Stone and R. West editors, published by the Academic Press (New York, 1979). Persons skilled in the art can easily determine an effective amount of platinum catalyst. Generally, an effective amount ranges from about 0.1 to 50 parts per million (ppm) of the total polysiloxane composition. Other exemplary effective ranges of the platinum catalysts are about 5 to 45 ppm of the total polysiloxane composition, about 10 to 40 ppm of the total polysiloxane composition, and about 20 to 30 ppm of the total polysiloxane composition.

The amount of catalyst present in the formulation ranges from about 1 to about 1000 ppm platinum by weight of the total formulation in one embodiment, from about 2 to about 100 ppm platinum by weight of the total formulation in another embodiment, from about 5 to about 50 ppm platinum by weight of the total formulation in yet another embodiment, and from about 10 to about 30 ppm platinum by weight of the total formulation in a further embodiment. Other exemplary ranges of the platinum may be employed in the present techniques.

A hydrosilylation catalyst inhibitor may be incorporated in the elastomer composition to modify the curing profile and to achieve the desired shelf life. Addition of hydrosilylation catalyst inhibitors may also delay the onset of curing and hence allow sufficient time for metallurgical bonding of micron and nano metal particles. Curing of polysiloxanes prior to metallurgical bonding may result in increase in viscosity and hence an intractable adhesive composition. Hydrosilylation catalyst inhibitors useful in the practice of the present invention include, but are not limited to maleates, alkynes, phosphites, alkynols, fumarates, succinates, cyanurates, isocyanurates, alkynylsilanes, vinyl-containing siloxanes and combinations thereof. Inhibitors such as esters of maleic acid (e.g. diallylmaleate, dimethylmaleate), acetylenic alcohols (e.g., 3,5 dimethyl-1-hexyn-3-ol and 2 methyl-3-butyn-2-ol), amines, and tetravinyltetramethylcyclotetrasiloxane and mixtures thereof can also be employed.

Examples of the micron-sized metal particles and the nano-sized metal particles include but are not limited to copper, silver, platinum, palladium, gold, tin, indium, or aluminum, or any combination thereof. According to some embodiments, the micron-sized particles and the nano-sized particles have substantially the same metallurgy. According to other embodiments, the micron-sized particles include a first metal and the nano-sized particles include a second metal different than the first metal, wherein the first metal and second metal are capable of forming a metallurgical bond.

The micron-sized metal particles may have a particle size and/or particle size distributions in exemplary ranges of about 1 micron to about 100 microns, 5 microns to 80 microns, 10 microns to 60 microns, 15 microns to 40 microns, and so on. The micron-sized particles may be present in the composition in a range from about 10 weight % to about 95 weight % of the total composition.

The nano-sized metal particles may have a particle size and/or particle size distributions in exemplary ranges of about 1 nanometer to about 250 nanometers, 5 nanometers to 200 nanometers, 10 nanometers to 150 nanometers, 25 microns to 100 nanometers, and so on. The nano-sized metal particles may be present in the composition in a range from about 2 weight % to about 50 weight % of the total composition. The micron-sized metal particles and nano-sized metal particles may include particles of various morphologies including flakes, substantially spheres, and combinations thereof.

Addition of nano-sized metal particles generally lowers the fusion temperature and facilitates the metallurgical-bonding to occur at manageable temperatures. Moreover, the nano particles generally increase the bulk electrical conductivity of the matrix, while maintaining a viscosity that allows relatively easy processing and manipulation. Furthermore, nano particles can penetrate into surface pores and irregularities inaccessible to micron-sized fillers, thereby reducing the effects on interfacial resistance. The presence of nano particles in the present compositions may also improve the stability of the composition when micron-sized particles are present. For example, the nano particles may prevent or decrease the rate of micron-sized particle settlement, thus reducing the likelihood of the formation of a metal particle-depleted layer in the interface material. Therefore, in certain embodiments, the metal nano particles of the adhesive compositions of the present technique may also be used to slow the phase separation of a polymer composition containing a micron-sized particle

The micron-sized metal particles and nano-sized metal particles are combined with the polymer matrix to form the present compositions. To facilitate combining the nano particles and micron particles with the polymer matrix, one or more solvents can be optionally added to the composition. Suitable solvents include, but are not limited to, isopropanol, 1-methoxy-2-propanol, 1-methoxy-2-propyl acetate, toluene, xylene, n-methyl pyrrolidone, dichlorobenzene and combinations thereof.

The final composition can be hand-mixed or mixed by standard mixing equipments such as dough mixers, chain can mixers, planetary mixers, twin screw extruder, two or three roll mill and the like. The blending of the components of the composition can be performed in batch, continuous, or semi-continuous mode by any means known to those skilled in the art.

According to one embodiment of the present invention, an adhesive composition having a cured polysiloxane and metallurgically-bonded micron-sized silver particles and nano-sized silver particles is presented.

According to another embodiment of the present invention, a method of making an electrically conductive adhesive composition is presented. This exemplary method may include contacting a curable low modulus elastomer with micron-sized metal particles and nano-sized metal particles. Furthermore, the method may typically include heating at a temperature in a range from about 150° C. to about 200 ° C. to form the adhesive composition. The resulting adhesive composition generally includes cured low modulus elastomer and metallurgically-bonded nano-sized metal particles and nano-sized metal particles. Further, the adhesive composition so formed is electrically conductive.

In one embodiment, the temperature of heating is selected such that during the elevated temperature curing process, the nano-sized metal particles metallurgically bond to each other, to other micron-sized metal particles, and to the substrate. The temperature of heating may also be selected such that simultaneous curing of the low modulus elastomer takes place. However, in this instance, because curing of the elastomer leads to reduction in the flowability of the metal particles, heating temperatures, are selected such that the curing process does not significantly hinder metallurgical-bonding between metal particles. Moreover, as noted earlier, a hydosilylation catalyst inhibitor is incorporated in the adhesive composition to delay the onset of curing and hence allow sufficient time for metallurgical bonding of micron and nano metal particles.

According to a further embodiment of the present invention, a method of making an adhesive composition having cured polysiloxane and metallurgically-bonded micron-sized silver particles and nano-sized silver particles is presented. The method includes contacting a curable polysiloxane with micron-sized silver particles and nano-sized silver particles. Furthermore, the method includes heating a temperature in a range from about 150° C. to about 200° C. to form the adhesive composition that is electrically conductive. However, it should be emphasized that temperatures falling outside of this exemplary range may be employed with the present techniques.

The present techniques provide for many applications of the conductive adhesives having metallurgically-bonded micron and nano particles as ECAs. For example, in the fabrication of electronic devices, integrated circuits, semiconductor devices, and the like, the electrically conductive adhesive compositions (ECAs) described herein, can find use as lead-free solder replacement technology, general interconnect technology, die attach adhesive, and as an electromagnetic interference/radio frequency interference shielding composite, and so forth. Integrated circuits and other devices employing the present ECAs may be used in a wide variety of applications throughout the world, including personal computers, control systems, telephone networks, and a host of other consumer and industrial products.

Integrated circuits, such as processors, memory devices, and other devices, may be fabricated on a semiconductor wafer using a variety of manufacturing processes, and they are generally mass produced by fabricating thousands of identical circuit patterns on a single semiconductor wafer and subsequently dividing them into identical die or chips. While integrated circuits are commonly referred to as “semiconductor devices,” they are in fact generally fabricated from semiconductor wafers having various materials including semiconductors (such as silicon in the wafer substrate), conductors (such as metals or doped polysilicones), and insulators (such as silicon oxide used, for example, to separate conductive elements). To produce integrated circuits many commonly known processes are used to modify, remove, and deposit material onto the semiconductor wafer. Processes such as ion implantation, sputtering, etching, physical vapor deposition (PVD), chemical vapor deposition (CVD) and variations thereof, such as plasma enhanced CVD, are among those commonly used.

The major fabricating steps for integrated circuits include film formation, impurity doping, photolithography, etching, and packaging. During packaging, the wafer is diced into small rectangles called die or chip, after which they are assembled into packages for protection and to make handling the small die easier. The protective packaging prevents damage to die or chip and provides an electrical path to the circuitry of the chip. The die is generally connected to a package using gold or aluminum wires which are welded to pads, usually found around the edge of the die. According to one embodiment of the present invention, ECAs may be as die-attach adhesives for connecting the die to the packaging material.

Generally, one die is assembled in one package. When more than one die is assembled into a common package, the resulting electronic assembly is called a multichip module (MCM). In this case, each chip is separated by an insulator and electrically connected via interconnects. According to one embodiment of the present invention, ECAs may be used as interconnects.

After packaging, the die assembly may be used in an electronic device by being electronically coupled to a printed circuit board of the device using surface-mount technology. In a surface mount technology, the die assembly is soldered to the same side of the board to which it is mounted. One example of surface-mounted devices comprises a circuit board having numerous connecting leads attached to pads located on its surface and a die assembly provided with small bumps or balls of solder positioned in locations corresponding to the bonding pads on the circuit board. After aligning the solder balls of the dye assembly with the bonding pads of the circuit board, the assembly is heated to melt the solder. After heating, the assembly is cooled to bond the chip assembly to the circuit board through solidified solder. Common solder materials include eutectic lead based alloys. As noted earlier, environmental concerns have resulted in a worldwide mandate to remove lead from all aspects of the microelectronic assembly process. According to another embodiment of the present invent, ECAs may be used as lead free-solder replacement technology. In another embodiment, ECAs may be used as electromagnetic interference/radio frequency interference shielding composite.

While the adhesive compositions of the present disclosure, are well-suited for use in ECA applications, the compositions of the present disclosure may also be used in resin systems for non-ECA applications that are required to be electrically conductive but require modification of another material property, such as thermal conductivity, modulus, dielectric constant, or index of refraction.

Application of the adhesives of the present invention may be achieved my any method known in the art. Conventional methods include screen-printing, stencil printing, syringe dispensing and pick-and place equipment.

The following examples are included to provide additional guidance to those skilled in the art. These examples are not intended to limit the invention in any manner.

### EXAMPLES

Small scale compounding of formulations were prepared in a Hauschild mixer in three cycles of 15 seconds at 2750 rpm with a short hand mix after each cycle. The first cycle consisted of the addition of the vinyl containing silicone polymer and the conductive fillers. The adhesion promoter, catalyst, inhibitor, and silicone hydride were added separately with hand mixes between each addition. More specifically, the inhibitor consists of diallyl maleate; the adhesion promoter consists of (bis(trimethoxypropyl)) fumarate the catalyst is known as Ashby's catalyst, a cyclic vinyl siloxane tetramer coordinated to platinum atoms.

All materials were cured at 150° C. for 1 hour. Viscosity was measured for examples 1 through 7, on a cone and plate viscometer (Brookfield DV-II@ 25° C.) at speeds where torque readings are above 40%. Bulk DC resistivity of samples was measured according to ASTM D2739-97 with 10 mA applied via a four point method. Settling time was determined by monitoring the formation of a skin layer in each formulation as a function of time.

Examples 1 to 7 provide the results obtained from the filler settling studies using different weight fractions of nano silver particles and micron silver particles. The settling time varied with the varying weight fractions of nano silver particles and micron silver particles. The settling time increased with increasing weight fraction of the nano silver particles in the formulation. Formulation with no nano silver particles settled in less than 24 hours, whereas a settling time of up to one year was observed for formulations with higher weight fraction of nano silver particles. Examples 8 to 13 provide the electrical performance results for formulations with different weight fractions of nano silver particles and micron silver particles. The electrical resistivities measured varied with varying weight fractions of the nano silver particles and micron silver particles. The resistivities measured varied in the range from about 170 μohms-cm to about 970 μohms-cm.

### Example 1

| Component-Type | Grams |
|---|---|
| Vinyl polymer-M^{vi}D₁₅₀M^{vi} | 0.819 |
| Silicone hydride-MD₅₀D^{H}₅₀M | 0.145 |
| Nanosilver | 0 |
| Micron Silver filler | 7.33 |
| Property (units) | Measurement |
| Viscosity (P) @ 20 rpm | 10.4 |
| Settling time | Within 24 hrs |

### Example 2

| Component-Type | Grams |
|---|---|
| Vinyl polymer-M^{vi}D₁₅₀M^{vi} | 0.819 |
| Silicone hydride-MD₅₀D^{H}₅₀M | 0.145 |
| Nanosilver | 0.4 |
| Micron Silver filler | 6.5 |
| Property (units) | Measurement |
| Viscosity (P) @ 20 rpm | 10 |
| Settling time | Within 24 hrs |

### Example 3

| Component-Type | Grams |
|---|---|
| Vinyl polymer-M^{vi}D₁₅₀M^{vi} | 0.819 |
| Silicone hydride-MD₅₀D^{H}₅₀M | 0.145 |
| Nanosilver | 0.8 |
| Micron Silver filler | 6.3 |
| Property (units) | Measurement |
| Viscosity (P) @ 20 rpm | 21.3 |
| Settling time | Within 7 days |

### Example 4

| Component-Type | Grams |
|---|---|
| Vinyl polymer-M^{vi}D₁₅₀M^{vi} | 0.819 |
| Silicone hydride-MD₅₀D^{H}₅₀M | 0.145 |
| Nanosilver | 0.9 |
| Micron Silver filler | 6.2 |
| Property (units) | Measurement |
| Viscosity (P) @ 20 rpm | 76 |
| Settling time | One week |

### Example 5

| Component-Type | Grams |
|---|---|
| Vinyl polymer-M^{vi}D₁₅₀M^{vi} | 0.819 |
| Silicone hydride-MD₅₀D^{H}₅₀M | 0.145 |
| Nanosilver | 1.0 |
| Micron Silver filler | 6.1 |
| Property (units) | Measurement |
| Viscosity (P) @ 20 rpm | 255 |
| Settling time | 3 months |

### Example 6

| Component-Type | Grams |
|---|---|
| Vinyl polymer-M^{vi}D₁₅₀M^{vi} | 0.819 |
| Silicone hydride-MD₅₀D^{H}₅₀M | 0.145 |
| Nanosilver | 1.22 |
| Micron Silver filler | 6 |
| Property (units) | Measurement |
| Viscosity (P) @ 20 rpm | 300 |
| Settling time | Up to one year |

### Example 7

| Component-Type | Grams |
|---|---|
| Vinyl polymer-M^{vi}D₁₅₀M^{vi} | 0.819 |
| Silicone hydride-MD₅₀D^{H}₅₀M | 0.145 |
| Nanosilver | 1.5 |
| Micron Silver filler | 5.7 |
| Property (units) | Measurement |
| Viscosity (P) @ 20 rpm | 355 |
| Settling time | Up to one year |

### Example 8

| Component-Type | Grams |
|---|---|
| Vinyl polymer-M^{vi}D₁₅₀M^{vi} | 8.19 |
| Micron Silver filler | 67.8 |
| Nanosilver filler | 8.8 |
| Adhesion promoter-Bis(trimethoxysilylpropyl | 0.099 |
| fumarate) | |
| Catalyst-1.75% solution of Pt(0) in D^{vi}₄ | 0.095 |
| Inhibitor-General Electric SL6040-D1 | 0.149 |
| Silicone hydride-MD₅₀D^{H}₅₀M | 1.45 |
| Property (units) | Measurement |
| Electrical Resistivity (μohms-cm) | 250 |

### Example 9

| Component-Type | Grams |
|---|---|
| Vinyl polymer-M^{vi}D₁₅₀M^{vi} | 8.19 |
| Micron Silver filler | 65 |
| Nanosilver filler | 3.1 |
| Adhesion promoter-Bis(trimethoxysilylpropyl | 0.099 |
| fumarate) | |
| Catalyst-1.75% solution of Pt(0) in D^{vi}₄ | 0.095 |
| Inhibitor-General Electric SL6040-D1 | 0.149 |
| Silicone hydride-MD₅₀D^{H}₅₀M | 1.45 |
| Property (units) | Measurement |
| Electrical Resistivity (μohms-cm) | 200 |

### Example 10

| Component-Type | Grams |
|---|---|
| Vinyl polymer-M^{vi}D₁₅₀M^{vi} | 8.19 |
| Micron Silver filler | 64 |
| Nanosilver filler | 5.7 |
| Adhesion promoter-Bis(trimethoxysilylpropyl | 0.099 |
| fumarate) | |
| Catalyst-1.75% solution of Pt(0) in D^{vi}₄ | 0.095 |
| Inhibitor-General Electric SL6040-D1 | 0.149 |
| Silicone hydride-MD₅₀D^{H}₅₀M | 1.45 |
| Property (units) | Measurement |
| Electrical Resistivity (μohms-cm) | 250 |

### Example 11

| Component-Type | Grams |
|---|---|
| Vinyl polymer-M^{vi}D₁₅₀M^{vi} | 8.19 |
| Micron Silver filler | 90 |
| Nanosilver filler | 2.3 |
| Adhesion promoter-Bis(trimethoxy- | 0.099 |
| silylpropyl fumarate | |
| Catalyst-1.75% solution of Pt | 0.095 |
| (0) in D^{vi}₄ | |
| Inhibitor-General Electric SL6040-D1 | 0.149 |
| Silicone hydride-MD₅₀D^{H}₅₀M | 1.45 |
| Property (units) | Measurement |
| Electrical Resistivity (μohms-cm) | 170 |

### Example 12

| Component-Type | Grams |
|---|---|
| Vinyl polymer-M^{vi}D₁₅₀M^{vi} | 8.19 |
| Micron Silver filler | 66.5 |
| Nanosilver filler | 10 |
| Adhesion promoter-Bis(trimethoxy- | 0.099 |
| silylpropyl fumarate) | |
| Catalyst-1.75% solution of Pt | 0.095 |
| (0) in D^{vi}₄ | |
| Inhibitor-General Electric SL6040-D1 | 0.149 |
| Silicone hydride-MD₅₀D^{H}₅₀M | 1.45 |
| Property (units) | Measurement |
| Electrical Resistivity (μohms-cm) | 396 |

### Example 13

| Component-Type | Grams |
|---|---|
| Vinyl polymer-M^{vi}D₁₅₀M^{vi} | 8.19 |
| Micron Silver filler | 61 |
| Nanosilver filler | 10 |
| Adhesion promoter-Bis(trimethoxy- | 0.099 |
| silylpropyl fumarate) | |
| Catalyst-1.75% solution of Pt | 0.095 |
| (0) in D^{vi}₄ | |
| Inhibitor-General Electric SL6040-D1 | 0.149 |
| Silicone hydride-MD₅₀D^{H}₅₀M | 1.45 |
| Property (units) | Measurement |
| Electrical Resistivity (μohms-cm) | 971 |

While only certain features of the invention have been illustrated and described herein, many modifications and changes will occur to those skilled in the art. It is, therefore, to be understood that the appended claims are intended to cover all such modifications and changes as fall within the true spirit of the invention.

1. An adhesive, comprising:
a cured low modulus elastomer; and
metallurgically-bonded micron-sized metal particles and nano-sized metal particles, wherein the adhesive is electrically conductive.

2. The adhesive of claim 1, wherein the low modulus elastomer comprises a polysiloxane comprising an average of at least two silicon-bonded alkenyl groups per molecule, a hydridopolysiloxane comprising at least two silicone-bonded hydrogen atoms, a hydrosilylation catalyst, and a hydrosilylation catalyst inhibitor.

3. The adhesive of claim 1, wherein the micron-sized metal particles and the nano-sized metal particles comprise copper, silver, platinum, palladium, gold, tin, indium, or aluminum, or any combination thereof.

4. The adhesive of claim 1, wherein the micron-sized particles and the nano-sized particles comprises substantially the same metallurgy.

5. The adhesive of claim 1, wherein the micron-sized particles comprises a first metal and the nano-sized particles comprises a second metal different than the first metal, wherein the first metal and second metal are capable of forming a metallurgical bond.

6. The adhesive of claim 1, wherein the micron-sized metal particles comprise particles of a size in a range from about 1 micron to about 100 microns.

7. The adhesive of claim 1, wherein the nano-sized metal particles comprise particles of a size in a range from about 1 nanometer to about 250 nanometers.

8. The adhesive of claim 1, wherein the micron-sized metal particles are present in the adhesive in a range from about 10 weight % to about 95 weight % of the total adhesive.

9. The adhesive of claim 1, wherein the nano-sized metal particles are present in the composition in a range from about 2 weight % to about 50 weight % of the total adhesive.

10. The adhesive of claim 1, wherein the micron-sized particles comprise flake-shaped particles or substantially sphere-shaped particles, or a combination thereof.

11. The adhesive of claim 1, wherein the nano-sized particles comprise flake-shaped particles or substantially sphere-shaped particles, or a combination thereof.

12. The adhesive of claim 1, wherein the adhesive comprises an electrically conductive adhesive.

13. The adhesive of claim 1, wherein:
the cured low modulus elastomer comprises a cured polysiloxane; and
the metallurgically-bonded micron-sized metal particles and nano-sized metal particles comprise silver particles.

14. A method of making an adhesive, the method comprising:
contacting a curable low modulus elastomer with micron-sized metal particles and nano-sized metal particles; and
heating to form the adhesive, wherein the adhesive comprises a cured low modulus elastomer and metallurgically-bonded micron-sized metal particles and nano-sized metal particles, wherein the adhesive is electrically conductive.

15. The method of claim 14, wherein the low modulus elastomer comprises a polysiloxane comprising an average of at least two silicon-bonded alkenyl groups per molecule, a hydridopolysiloxane comprising at least two silicone-bonded hydrogen atoms, a hydrosilylation catalyst, and a hydrosilylation catalyst inhibitor.

16. The method of claim 14, wherein the micron-sized metal particles comprise particles of a size in a range from about 1 micron to about 100 microns.

17. The method of claim 14, wherein the nano-sized metal particles comprise particles of a size in a range from about 1 nanometer to about 250 nanometers.

18. The method of claim 14, wherein the micron-sized metal particles are present in the adhesive in a range from about 10 weight % to about 95 weight % of the total adhesive.

19. The method of claim 14, wherein the nano-sized metal particles are present in the adhesive in a range from about 2 weight % to about 50 weight % of the total adhesive.

20. The method of claim 14, wherein the heating comprises heating at a temperature in a range from about 150° C. to about 200° C.

21. The method of claim 14, comprising:
contacting a curable polysiloxane with micron-sized silver particles and nano-sized silver particles; and
heating to form the adhesive, wherein the adhesive comprises a cured polysiloxane and metallurgically-bonded micron-sized silver particles and nano-sized silver particles, wherein the adhesive is electrically conductive.

22. The method of claim 21, wherein the curable polysiloxane comprises an average of at least two silicon-bonded alkenyl groups per molecule, a hydridopolysiloxane comprising at least two silicone-bonded hydrogen atoms, a hydrosilylation catalyst, and a hydrosilylation catalyst inhibitor.

23. An electronic device, comprising an adhesive comprising:
a cured low modulus elastomer; and
metallurgically-bonded micron-sized metal particles and nano-sized metal particles, wherein the adhesive is electrically conductive.

24. The electronic device of claim 23, wherein the adhesive comprises at least one of a lead-free solder connection, a eutectic solder connection, an interconnect in an integrated circuit within the electronic device, a die attach adhesive, or a shielding compositie for electromagnetic and radio frequency interference.

25. The electronic device of claim 23, wherein the metallurgically-bonded particles comprise sintered particles.

26. The electronic device of claim 23, wherein the metallurgically-bonded particles comprise fused particles.
